(19) United States
(12) Patent Application Publication
(10) Pub. No.: US 2008/0252555 A1
(43) Pub. Date: Oct. 16, 2008

(54) MULTIMEDIA NOTEBOOK HAVING SLIDING AUXILIARY DUAL MONITOR AND DESKTOP LCD MONITOR HAVING THE SAME

(76) Inventor: YOUNG HAK JEON, ICHEON-SI (KR)

Correspondence Address: IPLA P.A., 3580 WILSHIRE BLVD., 17TH FLOOR, LOS ANGELES, CA, 90010, US

(21) Appl. No.: 11/734,206

(22) Filed: Apr. 11, 2007

(51) Int. Cl. G09G 5/00

(52) U.S. Cl. 345/1.1

(57) ABSTRACT

Provided are a multimedia notebook having a sliding auxiliary dual monitor and a desktop LCD monitor. The multimedia notebook includes a main monitor including a receptible recess, an auxiliary monitor including second guide portion, and a main body. A first guide portion is formed at an inner surface of the receptible recess. The second guide portion contacts the first guide portion such that the auxiliary monitor is inserted into and ascends from the receptible recess. The main body is coupled to the main monitor with a hinge to control the main monitor and the auxiliary monitor. According to the multimedia notebook having a sliding auxiliary dual monitor and the desktop LCD monitor having the same, the auxiliary monitor that has ascended from the main monitor can rotate 360° to provide data and image to a user at the rear side of the auxiliary monitor.

### BACKGROUND OF THE INVENTION

1. Field of the Invention

The present invention relates to a multimedia notebook having a sliding auxiliary dual monitor and a desktop liquid crystal display (LCD) monitor having the same, and more particularly, to a notebook and a desktop LCD monitor suitable for a multimedia work environment.

2. Description of the Related Art

In general, a display device for a notebook and a desktop computer, such as a thin film liquid crystal display (LCD) monitor, is formed at one side of a main body to display data on a screen by operating a computer. Since a computer typically includes one monitor for displaying data of a main body, others excluding a user in front of a computer have a difficulty in understanding contents displayed on a screen. In addition, a user may watch two or more screens at the same time, for example, do multiple works with a monitor, or watch a broadcast while doing computer works. In this case, there is a limit on a screen size, and there is a limit on doing two works at the same time with one screen.

In order to watch TV using a computer with a conventional single monitor, a user should use an entire or a part of a monitor screen as a TV screen. Accordingly, when a user watches TV while doing other works, a screen for work becomes smaller, and thus reducing the work efficiency. Also, since a conventional dual monitor includes a main screen and an auxiliary screen formed integrally with each other, there is a limit on use when a user does not need a dual function or when a user use an auxiliary screen having a relatively small size independently in a vehicle.

In this regard, various studies have been conducted for providing a wide multimedia environment to a personal computer (PC) user.

For example, “Dual monitor having function of reception of TV and combining and separating of each other” is disclosed in Korean Laid-open Patent Publication No. 10-2003-0043238 (Jun. 2, 2003). Also, “TV display system of computer using dual monitor having main screen and auxiliary screen” is disclosed in Korean Laid-open Patent Publication No. 10-2002-0013313 (Feb. 20, 2002).

The above-mentioned inventions each have two or more monitors, but have low functionality and convenience for use. In detail, an auxiliary monitor is used by combination and separation, and thus it should be separately prepared, carried, and stored. Also, when an auxiliary monitor is foldable, the convenience for use is reduced and a user should prepare the auxiliary monitor manually for every works. That is, the auxiliary monitor cannot be mounted in a main monitor using a sliding method, and various multimedia environments have been not considered together with usual PC works.

### SUMMARY OF THE INVENTION

Accordingly, the present invention is directed to a method of forming a nanostructure having a high aspect ratio that substantially obviates one or more problems due to limitations and disadvantages of the related art.

It is an object of the present invention to provide a multimedia notebook having a sliding auxiliary dual monitor and a desktop LCD monitor having the same that have excellent practical use and outer appearance and are suitable for various multimedia environments together with usual PC works.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In an aspect of the present invention, there is provided a multimedia notebook having a sliding auxiliary dual monitor, the multimedia notebook including: a main monitor including a receptible recess with a first guide portion formed therein; an auxiliary monitor including a second guide portion which contacts the first guide portion such that the auxiliary monitor is inserted into and ascends from the receptible recess; and a main body coupled to the main monitor with a hinge to control the main monitor and the auxiliary monitor.

According to a multimedia notebook having a sliding auxiliary dual monitor and a desktop LCD monitor having the same of the present invention, an auxiliary monitor can slide to ascend from and descend into a main monitor, providing a wide work environment to a user. A user can watch TV or DMB with an auxiliary monitor while writing documents with a main monitor by mounting a DMB chip and a TV tuner in a notebook main body or a desktop LCD monitor. The auxiliary monitor that has ascended from the main monitor can rotate 360° to provide data and image to a user at the rear side of the auxiliary monitor. Also, when the auxiliary monitor is not necessary, it can be inserted into the main monitor, thereby simplifying the outer appearance and improving the work efficiency.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a multimedia notebook having a sliding auxiliary dual monitor according to an embodiment of the present invention;

FIG. 2 is a side view of FIG. 1;

FIG. 3 is a plan view of a main monitor with an auxiliary monitor inserted therein according to an embodiment of the present invention;

FIG. 4 is a plan view of a main monitor with an auxiliary monitor inserted therein according to another embodiment of the present invention;

FIG. 5 is a perspective view of a multimedia notebook having a sliding auxiliary dual monitor according to another embodiment of the present invention;

FIG. 6 is a block diagram of a multimedia notebook having a sliding auxiliary dual monitor according to an embodiment of the present invention;

FIG. 7 is a perspective view of a desktop LCD monitor having a sliding auxiliary dual monitor according to an embodiment of the present invention; and

FIG. 8 is a block diagram of a desktop LCD monitor having a sliding auxiliary dual monitor according to an embodiment of the present invention.

### DETAILED DESCRIPTION OF THE INVENTION

Reference will now be made in detail to the preferred embodiments of the present invention, examples of which are illustrated in the accompanying drawings. However, the present invention is not limited to the embodiments illustrated herein after, and the embodiments herein are rather introduced to provide easy and complete understanding of the scope and spirit of the present invention.

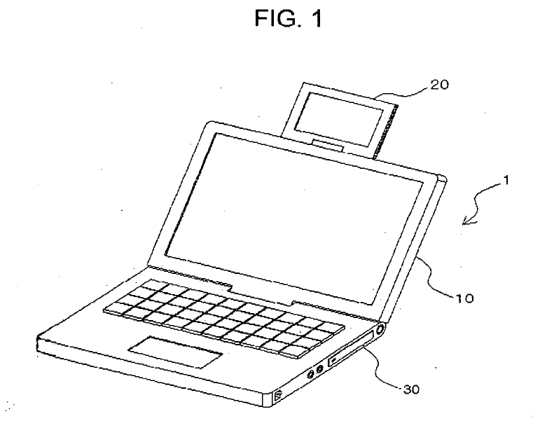

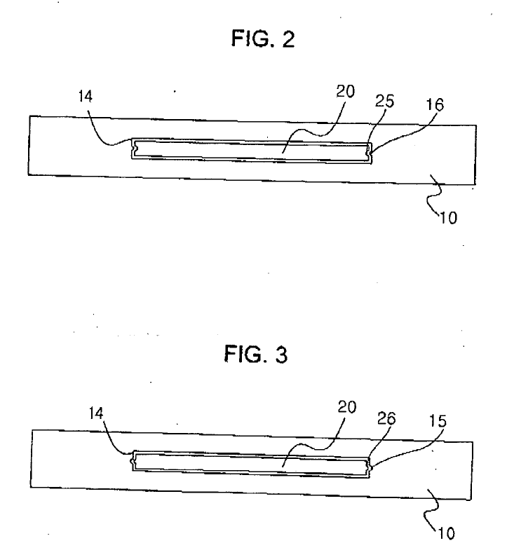

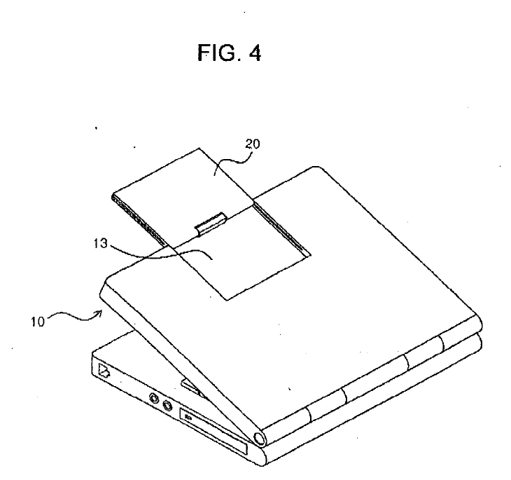

FIG. 1 is a perspective view of a multimedia notebook having a sliding auxiliary dual monitor according to an embodiment of the present invention. FIG. 2 is a side view of FIG. 1. FIG. 3 is a plan view of a main monitor with an auxiliary monitor inserted therein according to an embodiment of the present invention. FIG. 4 is a plan view of a main monitor with an auxiliary monitor inserted therein according to another embodiment of the present invention.

Referring to FIGS. 1 to 4, a notebook 1 includes a main monitor 10, an auxiliary monitor 20, and a main body 30.

The main monitor 10 includes a receptible recess 12 therein. The receptible recess 12 includes first guide portions 14 formed at its inner surface, and a roller (not shown) may be formed at the first guide portion 14. The main body 30 controls a driver motor (not shown) formed inside the main monitor 10. When the driver motor drives the roller, the auxiliary monitor 20 ascends from the receptible recess 12. In detail, the roller with elasticity is formed in the first guide portion 14, and second guide portions 22 are formed at side surfaces of the auxiliary monitor 20. The second guide portion 22 linearly slides in a length direction of the first guide portion 14 such that the auxiliary monitor 20 ascends from or descends into the receptible recess 12.

As described above, the roller may be installed between the first and second guide portions 14 and 22 so as to move the auxiliary monitor 20 without a separate guide rail. Alternatively, a protrusion such as a guide rail and a concave groove for movement of the guide rail may be formed for smooth ascent and descent of the auxiliary monitor 20.

A first guide rail 16 may be formed at the first guide portion 14 and a second concave groove 25 may be formed at the second guide portion 22 corresponding to the first guide portion 14. Therefore, the second guide portion 22 may slide in a length direction of the first guide portion 14 such that the auxiliary monitor 20 ascends from and descends to the main monitor 10. On the other hand, a first concave groove 15 may be formed at the first guide portion 14 and a second guide rail 26 may be formed at the second guide portion 22. Likewise, the second guide portion 22 may slide in a length direction of the first guide portion 14 such that the auxiliary monitor 20 ascends from and descends to the main monitor 10.

The auxiliary monitor 20 may move manually or using a separating button besides use of the above-described driver motor. In detail, a user may directly draw the auxiliary monitor 20 from the receptible recess 12 of the main monitor 10 if necessary, or may put the auxiliary monitor 20 in the receptible recess 12 if not necessary. Alternatively, a separating button (not shown) may be formed at the main monitor 10 or the auxiliary monitor 20, and the auxiliary monitor 20 may ascend from the receptible recess 12 of the main monitor 10 by elasticity by pushing the separating button.

A rotation member 24 is formed at a lower end of the auxiliary monitor 20 to rotate the auxiliary monitor 20 that has risen from the receptible recess 12 360°. The rotation member 24 rotates the auxiliary monitor 20 360° to provide data and image to a person at the rear side of the main monitor 10. A stop projection 17 is formed at an upper end of the receptible recess 12 and a stop protrusion 27 is formed at an outer circumference of the rotation member 24. The auxiliary monitor 20 that has been rising bumps against the stop projection 17. This prevents the separation of the auxiliary monitor 20.

A hinge member 28 may be formed at a lower end of the auxiliary monitor 20 such that the auxiliary monitor 20 can be tilted to a desired position. That is, contents displayed on the main monitor 10 is provided to a user at the rear side of the main monitor 10, even if the auxiliary monitor 20 is rotated 180°, the user at the rear side of the main monitor 10 cannot watch the contents of the auxiliary monitor 20 because of a bad viewing angle of the LCD monitor. Therefore, in order to improve the viewing angle of the auxiliary monitor 20, a front angle may be changed after rotating the auxiliary monitor 20 180°, as illustrated in FIG. 2.

As described above, when the auxiliary monitor 20 is inserted into the receptible recess 12 of the main monitor 10, the auxiliary monitor 20 is not exposed. However, the receptible recess 12 may be formed differently.

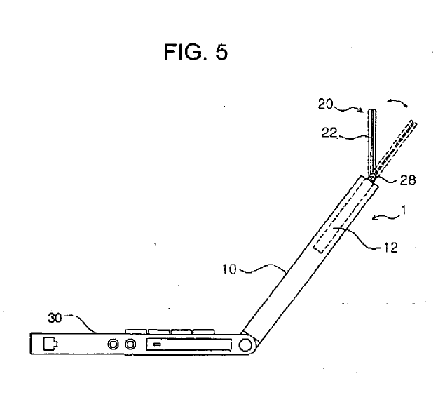

FIG. 5 is a perspective view of a multimedia notebook having a sliding auxiliary dual monitor according to another embodiment of the present invention. Referring to FIG. 5, even if the auxiliary monitor 20 is inserted into a receptible recess 13 formed at the rear surface of the main monitor 10, a surface of the auxiliary monitor 20 is exposed.

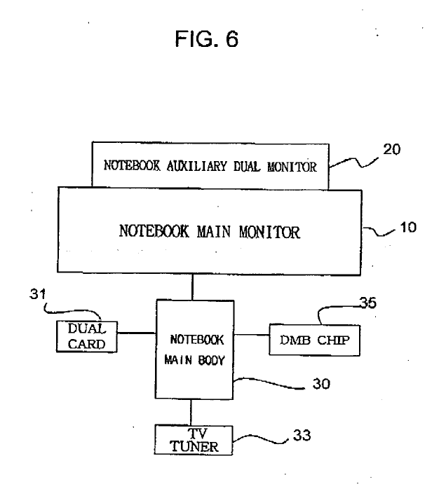

FIG. 6 is a block diagram of a multimedia notebook having a sliding auxiliary dual monitor according to an embodiment of the present invention. Referring to FIG. 6, a dual card 31 allows dividing a screen by dragging a plurality of images to the main monitor 10 and the auxiliary monitor 20, thereby facilitating user's works. A TV tuner 33 allows a user to watch TV with the auxiliary monitor 20 while using the main monitor 10. A digital multimedia broadcast (DMB) chip 35 provides DMB.

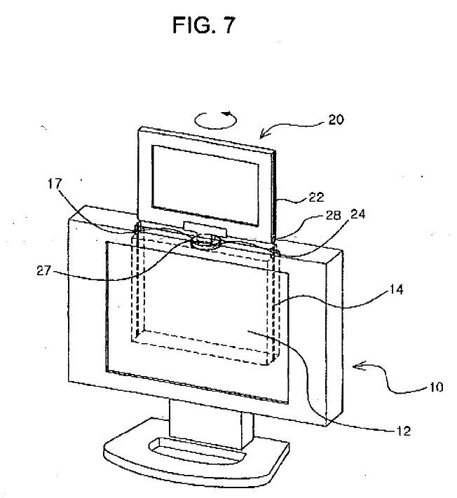

The present invention provides a multimedia desktop LCD monitor having a sliding auxiliary dual monitor for a desktop computer. FIG. 7 is a perspective view of a desktop LCD monitor having a sliding auxiliary dual monitor according to an embodiment of the present invention.

Referring to FIG. 7, the desktop LCD monitor includes a main monitor 10 and an auxiliary monitor 20. The desktop LCD monitor has the same elements as those of the multimedia notebook having the sliding auxiliary dual monitor, and thus a description thereof will not be repeated. The desktop LCD monitor may be used manually or using a separating button or a driver motor, and may include a receptible recess as illustrated in FIG. 5.

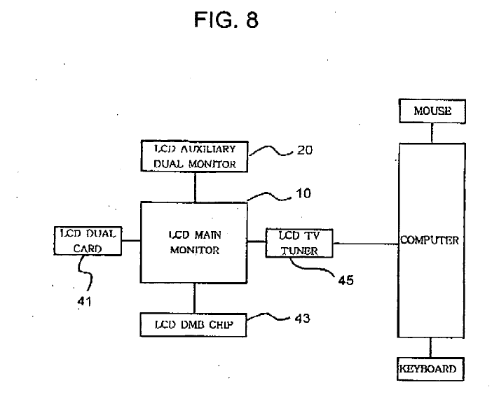

FIG. 8 is a block diagram of a desktop LCD monitor having a sliding auxiliary dual monitor according to an embodiment of the present invention.

Referring to FIG. 8, the LCD main monitor 10 includes a dual card 41, a DMB chip 43, and a TV tuner 45. The dual card 41 allows dividing a screen by dragging a plurality of images to the main monitor 10 and the auxiliary monitor 20, thereby facilitating user's works. The DMB chip 43 provides DMB. The TV tuner 45 allows a user to watch TV with the auxiliary monitor 20 while using the main monitor 10. Therefore, with the dual monitor according to the present invention provides, a user can use various multimedia contents easily and effectively while doing computer works.

According to a multimedia notebook having a sliding auxiliary dual monitor and a desktop LCD monitor having the same of the present invention, an auxiliary monitor can slide to ascend from and descend into a main monitor, providing a wide work environment to a user.

A user can watch TV or DMB with an auxiliary monitor while writing documents with a main monitor by mounting a DMB chip and a TV tuner in a notebook main body or a desktop LCD monitor. The auxiliary monitor that has ascended from the main monitor can rotate 360° to provide data and image to a user at the rear side of the auxiliary monitor. Also, when the auxiliary monitor is not necessary, it can be inserted into the main monitor, thereby simplifying the outer appearance and improving the work efficiency.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A multimedia notebook having a sliding auxiliary dual monitor, the multimedia notebook comprising:
a main monitor including a receptible recess with a first guide portion formed therein;
an auxiliary monitor including a second guide portion which contacts the first guide portion such that the auxiliary monitor is inserted into and ascends from the receptible recess; and
a main body coupled to the main monitor with a hinge to control the main monitor and the auxiliary monitor.

2. The multimedia notebook of claim 1, wherein a roller having elasticity is formed at the first guide portion such that the second guide portion slides in a length direction of the first guide portion.

3. The multimedia notebook of claim 1, wherein the main monitor further comprises a driver motor for driving a roller formed at the first guide portion.

4. The multimedia notebook of claim 1, wherein a first guide rail is formed at the first guide portion and a second concave groove is formed at the second guide portion corresponding to the first guide portion such that the second guide portion slides in a length direction of the first guide portion.

5. The multimedia notebook of claim 1, wherein a first concave groove is formed at the first guide portion and a second guide rail is formed at the second guide portion such that the second guide portion slides in a length direction of the first guide portion.

6. The multimedia notebook of claim 1, wherein the auxiliary monitor descends into and ascends from the receptible recess manually.

7. The multimedia notebook of claim 1, wherein the auxiliary monitor ascends from the receptible recess by elasticity by using a separating button.

8. The multimedia notebook of claim 1, wherein a rotation member is formed at a lower end of the auxiliary monitor to rotate the auxiliary monitor that has ascended from the receptible recess 360°.

9. The multimedia notebook of claim 1, wherein a stop projection is formed at an upper end of the receptible recess and a stop protrusion is formed at an outer circumference of a rotation member such that the auxiliary monitor that has been rising bumps into the stop projection.

10. The multimedia notebook of claim 1, wherein a hinge member is formed at a lower end of the auxiliary monitor to change a front angle.

11. The multimedia notebook of claim 1, wherein the receptible recess is formed at the rear surface of the main monitor such that a surface of the auxiliary monitor is exposed when the auxiliary monitor is inserted into the main monitor.

12. The multimedia notebook of claim 1, wherein the main body includes a dual card dividing a screen by dragging a plurality of images to the main monitor and the auxiliary monitor, a TV tuner allowing a user to watch TV with the auxiliary monitor while using the main monitor, or a DMB chip for supplying DMB.

13. The multimedia notebook of claim 2, wherein the main monitor further comprises a driver motor for driving a roller formed at the first guide portion.

14. A multimedia desktop LCD monitor having a sliding auxiliary dual monitor, the multimedia desktop LCD monitor comprising:
a main monitor including a receptible recess with a first guide portion formed therein; and
an auxiliary monitor including a second guide portion which contacts the first guide portion to allow the auxiliary monitor to descend into and ascend from the receptible recess.

15. The multimedia desktop LCD monitor of claim 14, wherein the main monitor includes a dual card dividing a screen by dragging a plurality of images to the main monitor and the auxiliary monitor, a TV tuner allowing a user to watch TV with the auxiliary monitor while using the main monitor, or a DMB chip for supplying DMB.
